(19) United States
(12) Patent Application Publication
(10) Pub. No.: US 2004/0141621 A1
(43) Pub. Date: Jul. 22, 2004

(54) Method for testing a hearing device

(76) Inventors: Maurice Boonen, Winterthur (CH); Thomas Raymann, Rapperswil (CH)

Correspondence Address: PEARNE & GORDON LLP, 1801 EAST 9TH STREET, SUITE 1200, CLEVELAND, OH, 44114-3108, US

(21) Appl. No.: 10/345,516

(22) Filed: Jan. 16, 2003

(51) Int. Cl. H04R 29/00

(52) U.S. Cl. 381/60

(57) ABSTRACT

A low price, easy practicable testing method is provided for a hearing device which comprises an input acoustical/electrical converter, an output electrical/acoustical converter and an interlinking computing unit which method comprises stimulating by means of the output converter of the device the input converter in a surrounding whereat both acoustical input and acoustical output of the converter are freely accessible and acoustical signals may freely transit from such output to such input in non test specific surrounding.

The present invention is generically directed on a method for testing hearing devices and to a method for manufacturing hearing devices which are tested.

Thereby such a hearing device has an input acoustical/electrical converter, an output electrical/acoustical converter and a computing unit operationally connecting input to output converter Such a hearing device may be an in-the-ear device or an outside-the-ear device and thereby a hearing aid device for therapeutical appliances for hearing impaired individuals or may be a consumer hearing device as for head sets, ear pieces, ear phones, active anti-noise devices etc.

Whenever proper functioning of such hearing devices is to be tested, customarily the device is installed within a unechoical surrounding and testing is performed making use of an external acoustical/electrical converter as well as of an external electrical/acoustical converter. There is further provided a signal generator and a analysing unit to stimulate on one hand the external acoustical/electrical converter and to analyse on the other hand the result acoustical signal from the external electrical/acoustical converter.

This testing thus necessitates a laboratory-type testing equipment and surrounding Such testing may only be performed at well equipped locations and by well trained staff.

From the DE 100 46 098 a method is known for testing the above mentioned hearing devices which is considerably simpler, as concerns testing equipment required, as well as education of testing staff.

Thereby the internal electrical/acoustical output converter of the device is exploited to stimulate the internal acoustical/electrical input converter of the device. The signal transfer path between output of the input converter and input of the output converter is interrupted. A well defined acoustical transmission line is thereby applied between the output of the output converter and the input of the input converter. Very similarly the US 2003/0007647 proposes to apply as such well defined acoustical transmission line a compartment with hard walls, so that the large part of the generated acoustic signal is received by the input transducer.

It is an object of the present invention to further simplify such a testing procedure. This is achieved according to the present invention by the method for testing a hearing device with an input acoustical/electrical converter, having an acoustical input, an output electrical/acoustical converter having an acoustical output, and having further a computing unit with an input which is operationally connected to the output of the acoustical/electrical input converter and with an output which is operationally connected to the input of the electrical/acoustical output converter The method comprises the steps

a) placing the device in a position with freely accessible and freely communicating acoustical input and acoustical output without providing an acoustical transmission line from acoustical output to acoustical input;

b) generating at least one electric drive signal representing an acoustical signal

c) driving the output converter with an electrical signal which is a function of the drive signal

d) tapping off an electrical signal dependent from a signal at the output of the input converter and

e) determining from the signal tapped off characteristics of signal transfer in said device.

Thereby it has been recognized that a special acoustic connection line, as considered imperative by the teaching of the DE 100 46 098 or the US 2003/0007647, is in fact not necessary so that according to the present invention no special equipment is necessitated for performing the test beside an analyzing computer. Such test thus may be realized practically in every “reasonable” stable surrounding for acoustical tests i.e. with no too high back ground noise and with acoustically reflecting surfaces not too close to the device under test, e.g. not closer than 0.1 m. Such surroundings are usually found practically everywhere so that the test may in fact be performed even by the individual owner of the hearing device at least for achieving first indications of wellfunction/malfunction of his device. It is proposed in a preferred embodiment to generate the electrical drive signal representing the acoustical signal to result in acoustical power which is sufficiently higher than acoustical noise signals emanating from the surrounding of the device, e.g. by a factor of at least 3. Thereby, the surrounding noise may be detected and the generated acoustical signal may be adapted to the detected noise situation; this can be performed with respect to level, frequency-content as well as by time-slot-technique.

In a further preferred embodiment determining from the signal tapped off, signal components which are depending from the drive signal is performed with special measures. Thereby such determining is preferable performed by correlating the signal tapped off and the drive signal which is predetermined.

Although in one embodiment the generator for driving the output convert is external to the hearing device, may e.g. be integrated in a testing computer which also incorporates the analysing unit for determining the characteristics of signal transfer from the tapped off signal, in one further preferred embodiment, such generator is incorporated into the hearing device. Thereby in a further preferred embodiment more than one electric drive signal may be controllably generated by the generator.

By the fact that the generator is preferably incorporated into the hearing device the number of the external data feeds to the hearing device is reduced.

By providing more than one driving signal by the generator in a selected manner, such signals may be adapted to suite the specific characteristics of the device to be monitored and tested and/or to the acoustical environment.

Preferably determining of the characteristics of signal transfer of the device is performed by comparing the monitored signals which are dependent from the signals tapped off with predetermined rated signal values. Thereby comparison results may be binary, just indicating proper functioning of the device or malfunctioning of the device which may easily be displayed at the hearing device itself e.g. by sound or visual indications.

So as to achieve a even higher flexibility with respect to by whom or where such testing may be performed, it is further preferred to store the device specific predetermined rated signal values within the hearing device. Thereby it becomes not anymore necessary that at a testing location, a databank be available with all rated signal values of all different types of hearing devices.

A further degree of independence from testing equipment is achieved by performing determining of the characteristics within the hearing device itself. Thereby such determining may result, as was mentioned above, in a binary first indication of functioning/malfunctioning of the device whereby later the device will be tested more accurately. Whereas first testing just on functioning/malfunctioning may be performed by the individual owner of the hearing device himself in the case of indicated malfunctioning the device will be more accurately tested as by performing the method according to the present invention in more accurate way making use of a more sophisticated analysing unit and displaying more specific results at a specialised and better equipped location.

The method according to the present invention may be performed without interrupting the electrical signal transfer path from the output of the input converter to the input of the output converter thereby establishing by the acoustical output to input link a closed-loop system. Stimulated by the electrical signal driving the output converter it is the closed-loop behaviour of such system, as e.g. with respect to resonance behaviour and oscillation dampening which gives first characteristics, indicative of proper or non-proper functioning of the device.

In a further preferred mode it is nevertheless, instead of closed-loop testing or additionally thereto, provided the possibility to disable the operational connection between output of the input converter and input of the output converter at a predetermined location along the electrical signal transfer path through the hearing device. Thereby the output converter is driven with a electrical signal by coupling that signal into the signal transfer path upstream said disabling. Tapping off of the electrical signal dependent from the signal at the acoustical output of the input converter is performed downstream the disabling location.

So as to become able especially for more accurate testing, specifically find a malfunctioning unit along the signal transfer path, in a further preferred embodiment of the method according to the present invention, at least two locations are provided upstream the disabling location of the electrical signal transfer path between input and output converters, whereby coupling-in of the electric signal for driving the output converter may selectively be, performed to either of the said location provided.

In a further preferred embodiment there is performed selective switching of the electric signal for driving the output converter to said locations.

In another preferred embodiment of the method according to the present invention there are provided more than one location downstream the disabling location along the electrical signal transfer path for tapping off the electrical signal which is dependent from the acoustical signal at the output of the input converter. Further preferred selective switching of the tapped off signal to either the said locations is performed.

The minimum open loop configuration to be tested consists of input converter and output converter at the electrical signal transfer path being tested. Thereby in the case of detecting malfunctioning, there remains ambiguity with respect to which of these converters might be malfunctioning. So as to remedy for such ambiguity there is first applied an acoustical signal from an external signal source to the input converter which per se is thereby analysed leading to information whether this input converter is properly functioning or not. Thereby if there is a hearing device available whereat the output converter has been tested and found well-functioning and which—preferably —has the same characteristic as the output converter under test, then, as an external source, the output converter of such second hearing device may be used.

Once functioning of the input converter is determined, a step by step analysis may be performed to get information about functioning of each of the units concomitantly providing for the overall electrical signal transfer path between the converters.

If the hearing device comprises more than one input converter than such ambiguity as mentioned may be excluded by testing both minimum signal transfer paths from one input converter to the output converter and from the other input converter to the same output converter. Comparing results of these two tests will indicate whether the output converter or one the input converters is malfunctioning.

In a further preferred embodiment also the characteristics of the electrical signal transfer path as result of the test are stored, thereby preferably within the hearing device. This makes it possible for a specific hearing device to monitor the development of its characteristics e.g. due to aging or due to being exposed to user's care.

A test system according to the present invention and performing the test according to this invention just consists of the hearing device to be tested which has a data link to an evaluation unit. Thereby such data link to an external evaluation unit may be one of wireless and of wired.

Under a further aspect the present invention provides for a method of manufacturing tested hearing devices, having being tested in a simple, non expensive and nevertheless accurate manner. This method of manufacturing comprises assembling the hearing device at least with at least one input converters an output converter and an interlinking computing unit, generating by mean of the output converter at least one acoustical test signal, freely transmitting such acoustical test signal from the output of the output converter to the input of the input converter and analysing at least one signal tapped off the hearing device between the output of the input converter and the input of the output converter as an indicative signal of malfunctioning or wellfunctioning of the device and selectively, differently treating a hearing device which is malfunctioning and a hearing device which is wellfunctioning.

The present invention shall now be described more in detail and by way of examples with a help of figures. These figures show:

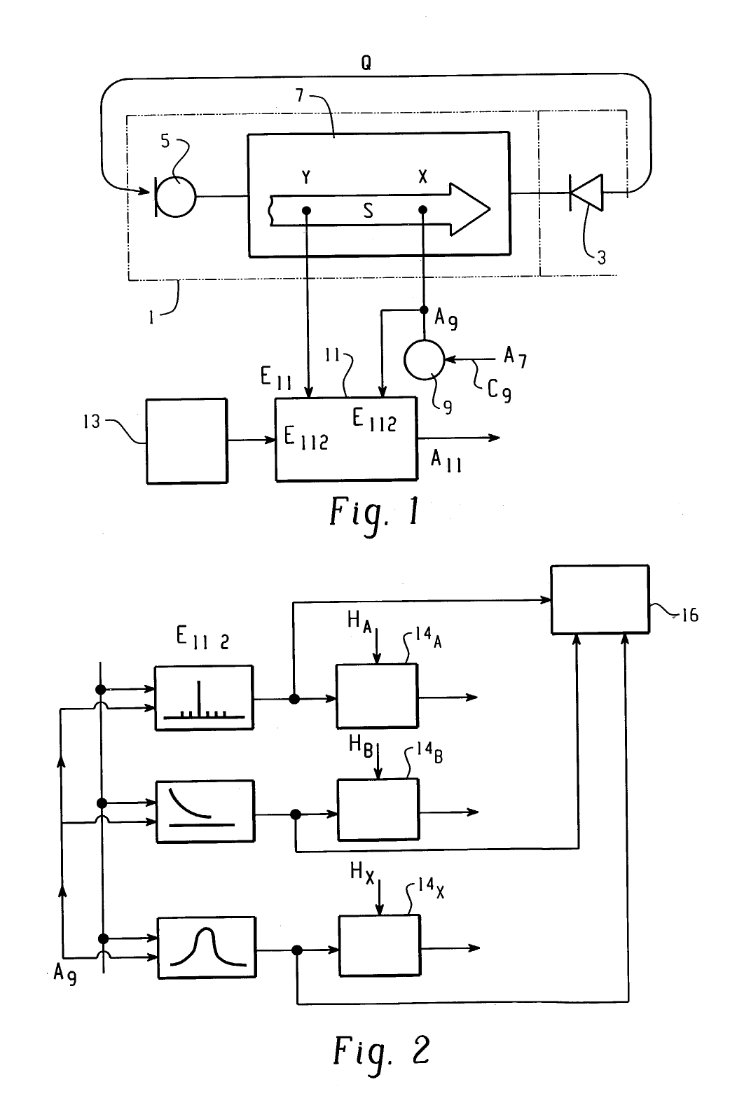

FIG. 1 with the help of a functional block/signal flow diagram a first preferred embodiment of the testing method or of a testing system according to the present invention

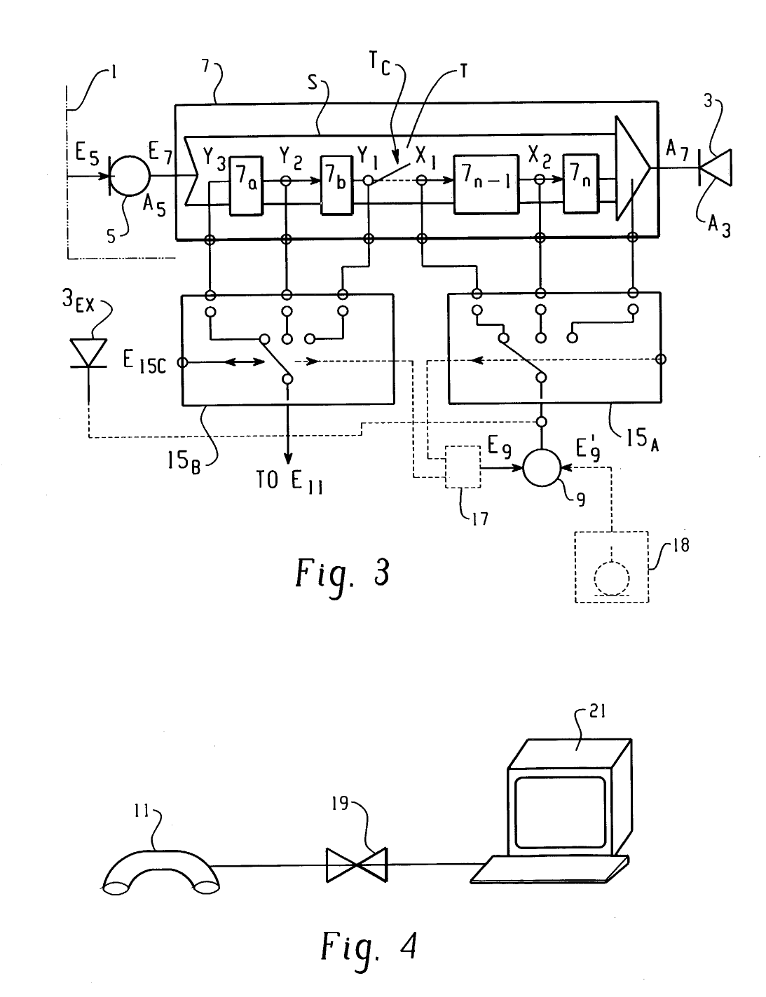

FIG. 2 again schematically and with the help of a signal flow/functional block diagram possible analysis of monitored signals at the embodiment of FIG. 1 but also principally at an embodiment according to FIG. 3 taking into account that the signal stimulating the overall system is predetermined.

FIG. 3 again in a schematic signal flow/functional block representation a further preferred embodiment according to the testing method or according to the testing system of the present invention

FIG. 4 schematically a testing system according to the present invention.

In FIG. 1 there is schematically shown a most generic approach of testing a hearing device according to the present invention.

A hearing device 1 may be an in-the-ear hearing device or an outside-the-ear hearing device, It further may be a hearing aid device for improving hearing of a hearing-impaired individual or a hearing device for other purposes than therapeutical as e.g. for an antinoise headset, consumer headset, consumer earphones, telephones etc.

The hearing device comprises at least one output electrical/acoustical converter 3 and at least one input acoustical/electrical converter 5. The electrical output A₅ of converter 5 is operationally connected to an input E₇ of a signal computing unit 7, the output A₇ thereof being operationally connected to the electric input E₃ of the output converter 3.

According to the present invention and for performing testing according to the present invention, the hearing device 1 is placed in a non testspecific surrounding with the acoustical output of output converter 3 and the acoustical input of input converter 5 freely accessible and allowing free propagation of acoustical signals from converter 3 to converter 5 in ambient surrounding as schematically shown by Q in FIG. 1, such communication being not bared or hindered or fed along a specific acoustical communication line. Thereby, the device 1 is held in position during testing by a holding member (not shown) as by a hook, a receptacle or just hangs freely on a communication-link cable to an analyzing unit as to an analyzing computer. By means of a signal source 9 generating an electric output signal at an output A₉, there is generating an electrical signal which represent an acoustical signal. This electrical output signal of generator 9 is fed to a location X along an electrical signal transfer path S from output of input converter 5 to input of output converter 3. Thereby the output converter 3 is driven by an electric signal which is dependent from the output signal of generator 9, to generate a respective acoustical output signal.

This acoustical output signal at the acoustical output A₃ of converter 3 is picked up by input converter 5 and converted into an electrical signal at output A₅ which is transferred through the computing unit 7 along transfer path S. At a predetermined locus Y along the signal transfer path S, between output A₅ and input E₃ an electrical signal which depends from the acoustical signal is tapped off. This tapped off signal is fed to an input E₁₁ of an analysing unit 11. As the signal generated at source 9 is known and predetermined, the signal fed to the input E₁₁, of analysing unit 11 is indicative of signal transfer characteristics of the electrical signal transfer path S inclusive converters 3 and 5

In the embodiment according to FIG. 1 and without further measures taken, the device 1 together with the acoustic signal transmission path Q represents a closed loop system.

By analysing the signal fed to the input E₁₁, of unit 11, as response to a stimulus signal generated by generator 9, signal response characteristics of the closed loop system is analysed. The predetermined signal generated at generator 9 may thereby be e.g. a single frequency sinus signal whereby such frequency may be swept over a predetermined frequency band as e.g. along the significant frequency band of speech, This signal generated by generator 9 may e.g. also be a step like switched on sinus signal, shaped noise signal or a pulsed sinus signal. The system response as with respect to transient behaviour, dampening and/or resonance frequency and/or phasing is analysed. Thereby, depending on the type of response analysis performed the output signal of the generator 9 is also fed to analysing unit 11, as shown in fig 1 at input E₁₁₂, to form a respective quotient response/stimulus result. Thereby result signals are formed at output A₁₁ significant of the signal transfer behaviour of the device 1.

As shown in FIG. 2 still schematically, the input E₁₁ is e.g. led within analysing unit 11 to, one or more than one analysing subunit E_{11A} . . . . whereat the tapped off signal from Y is analysed on specific characteristics of the closed loop configuration as on resonance frequency ωᵣ dampening α sharpness of resonance peak Q etc. Thereby the respective characteristic values as monitored are compared at respective comparator units 14_{A} . . . with predetermined characteristic values as shown in FIG. 2 by W_{A} . . . . Thus in these comparator units 14_{A} . . . 14_{X} instantaneously prevailing characteristic values are compared with the rated values as Of W_{A} to W_{X}. The rated values are thereby, as again shown in FIG. 1, stored in a reference value storage unit 13. They have been determined by calculation and/or by previous measurings at standard devices. Clearly, definite information on well/malfunctioning of the device under test may be derived from logical combinations of comparison results from units 14.

As shown in FIG. 1 more generically rated values W are fed via input E₁₁₃ to analysing unit 11. At the output A₁₁ of analysing unit 11 there is thus generated either a binary signal, directly indicating whether the device under test, having in fact been compared with a standard device, fulfilles the required conditions and is wellfunctioning or not. On the other hand the signals appearing at the outputs of the respective subunits E_{1lA} . . . . may additionally or instead be evaluated indicating the behaviour of the instantaneously monitored characteristic values.

Generically the test results may be stored in a result storage 16 as shown in FIG. 2. Thereby the rated value storage unit 13 as well as the result storage unit 16 may be preferably incorporated into the device 1. By incorporating rated value storage 13 within the device 1, such device may be tested very flexibly without the need of having the specific rated values available in a databank of the testing facility: The rated values are provided in the specific hearing device. By having the result storage 16 integrated into the hearing device 1, subsequent testing may show the evolution of the characteristics monitored thereby being e.g. an indicia of device aging.

Further it is also possible to integrate signal generator 9 in the hearing device 1, e.g. preprogrammed, to generate at least one preferably more than one predetermined stimulus signals which may be triggered by a code entered to a generator control input C9 at the device 1.

When according to FIG. 1 closed-loop behaviour of the hearing device 1 is examined, all components of the device from the input converter 5 up to the output converter 7 are analysed with respected to combined signal transfer behaviour. Thereby it will often not be possible to exactly conclude from the analysis results which of the hearing device's components is the cause of an erroneous signal transfer behaviour.

Nevertheless it might be desired not only to monitor closed-loop overall behaviour of the hearing device 1 but to monitor specific components or groups of components of the hearing device as selected. This may be done by open-loop testing. As will be exemplified with the help of FIG. 3, testing the device 1 in open-loop configuration provides for the possibility of step-by-step analysing predetermined components or units contributing to the overall signal transfer of device 1.

According to FIG. 3 the signal transfer path S as of FIG. 1 is exemplified by the subunits 7ₐ up to 7ₙ by which the signal applied to be the input E₅ is treated before being emitted at the output A₃. So as to be able to open the closed-loop as shown in FIG. 1 there is provided along the electrical signal transfer path S a controlled switching member T with a control input T_{c} by which the signal transfer path along unit 7 may be interrupted.

Thus, whenever the switch T is opened and generator 9 feeds a signal representing an acoustical signal to locus X₁ just upstream the open switch T and further analysing unit 11 (not shown in FIG. 1) is fed by a signal tapped off at location Y1, as marked in FIG. 3, the signal to be analysed and fed to E₁₁ is dependent from the transfer characteristics of all the unit 7, inclusive the two converters 5 and 3.

Whenever the output signal of generator 9 is e.g. fed to locus X2, then the signal still from Y₁ and fed to E₁₁, of analysing unit 11 will be dependent on signal transfer characteristics of all the units 7ₐ . . . with the exception of unit 7ₙ₋₁.

Thus, and as schematically shown in FIG. 3, in a preferred embodiment of the present invention beside of providing a controlled switch T to open-loop the measuring or testing system there are provided more than one input location X from generating unit 9 to the signal transfer path S, and more than one tap-off location Y.

According to FIG. 3 there is preferably provided a multiplexer unit 15_{A} so as to selectively feed the generator signal from the output of generator 9 to selected locations X along the transfer path S of the device upstream switch T and/or as shown by 15_{B} a multiplexer unit to selectively tap-off a signal to be analysed from different locations Y along the signal transfer path S of the device 1.

Thereby it might be advantageous to respectively select the test signals generated by generator 9 in dependency of which specific units along the signal transfer path S are incorporated in the instantaneously tested system branch. Thereby establishing a dependency of the instantaneous positions of multiplexer 15_{A}, of multiplexer 15_{B} and of the signal generated by generator 9 is shows in FIG. 3 in dashed lines. The selection unit 17 thereby selects at a control input E₉ of generator 9 in dependency of multiplexer positions the signal to be generated by generator 9. There may further be provided a detector arrangement 18 which picks up and evaluates surrounding noise situation and which controls as at control input E′₉ the generator 9, to generate signals adapted to the prevailing noise situation. Generator 9 may generate e.g. single or multiple sinus signals, possibly swept over a predetermined frequency band, with different amplitudes of such signals, wide spectral signals with predetermined amplitude distribution, possible with varying amplitude distribution, band limited noise-signals etc. as testing signals Further all these signals may be generated by generator 9 in an intermittent, pulsed manner.

When considering the preferred embodiment of FIG. 3 it becomes apparent that, whenever the output signal of generator 9 is fed to the signal transfer path S just downstream the output converter 3 and simultaneously the signal to be analysed is tapped off just upstream the input converter 5, then only that part of the signal transfer path S consisting of the two converters 5 and 3 will be tested. A further reduction of the signal path tested is not possible

Therefore there will always be incertitude of overall testing with respect to functioning of the two converters 3 and 5 i.e. even when the transfer path under test is minimum there remains incertitude which of the two converters 3 and/or 5 is possibly malfunctioning.

So as to remedy this incertitude it is proposed, e.g. before starting further testing, to provide a standard external loud speaker 3_{EX} preferably operationally connectable to the output of generator 9 and to test input converter 5 by at least one acoustical standard signal. This is performed by tapping off the signal fed to analysing unit 11 just upstream the output of input converter 5. By this procedure functioning or malfunctioning of input converter 5 per se is evaluated thereby making subsequent tests as where described above non-ambiguous. As an external loudspeaker 3_{EX} the output electrical/acoustical converter of a second hearing device may be used, if proper functioning of latter is established.

The multiplexer units 15A and 15B may be incorporated into the hearing device 1. Control inputs E_{15c} by which the respective positions of the multiplexer units are controlled are then accessible from outside the hearing device as well as output A₁₅ and input E₁₅, after of generator 9 is external device 1. Nevertheless in a preferred embodiment generator unit 9 is provided in the hearing device 1 and may preferably be controlled with respect to the signal generated, by control input E₉ accessible from the outside of the hearing device 1 by a wired or wireless link.

We have explained how the minimum transfer path namely consisting of the two converters 3 and 5 may be tested and that thereby such test may be made unambiguous by applying via a external sound source 3_{EX} an acoustical signal to the input converter 5 prior to further testing.

Nevertheless, hearing devices are well known which comprise more than one input acoustical/electrical converters 5 e.g. for beam forming purposes. Whenever more than one input converter 5 is provided, another possibility is to compare characteristics of such minimum signal transfer paths with different input converters 5 and the one output converter 3 to evaluate which of the two input converters may be malfunctioning.

Analysis of the tapped off signal E₁₁ in the embodiment of FIG. 3 is performed in analogy to the explanation with respect to FIG. 2. Here too a rated value storage and/or a result value storage may be provided, preferably incorporated in the hearing device.

In a most preferred embodiment of a hearing device for performing of the test as was explained, the analysing unit 11, the generator 9 and the rated value storage 13 as well as the result storage unit 16 are all incorporated within the hearing device. Additionally and if provided signal multiplexers as were shown in context with FIG. 3 are also incorporated in the hearing device. Thereby the analysing unit which is incorporated in the device, may be tailored just for a first and rather rough information of the device's functioning and such analysis result may be displayed at the hearing device e.g. by an optical signal or a sound signal, indicating either that the device is properly functioning or that the device should be brought to a authorized location for further analysis and possible repair. Thereby the individual owner of the device himself may perform such a first device testing.

The overall testing according to the present invention may be applied during the manufacturing process of the hearing devices and/or is applied at a seller-or service-location. For more complex testing the hearing devices are just connected to an analysing computer with the analysing unit 11 and are tested in a normal surrounding. Connection is thereby established by a wire bound or wireless data link.

In FIG. 4 there is schematically shown the testing system to perform testing according to the present invention. It comprises the hearing device 1 just connected by a wire bound or wireless data link 19 to a computer 21 or, more generically processing unit, which incorporates at least the analysing unit 11 as was described before. By the computer 21 test controlling as of controlling the signals generated by generator 9, controlling multiplexer positions in an embodiment according to FIG. 3, opening and closing switching arrangement T etc is performed.

An important feature of the method according to the present invention is, as was said, that the hearing device is tested in a surrounding which is not a specific acoustical testing surrounding with narrow acoustical requirements.

Although complex mathematically procedures are known to recover signal components resulting from a predetermined source signal out of a signal which comprises such signal but additionally comprises any kind of noise as well as the source signal received with different timelags, due to multiple reflectance, and such procedures may also be applied for signal recovery in the test according to the present invention, in a preferred embodiment the test is performed in a “reasonably silent” environment, and insensitivity level of the signal generated by generator 9 is selected to be significantly higher, preferably at least by a factor of 3, than disturbing acoustical signals from the surrounding. Further relatively simple measures may be applied to recognize at the tapped off signal those signal components which are dependent from the output signal of generator 9, such as frequency selective measures or time delay selective measures. As the signal of generator 9 it known relatively simple correlation—techniques may be used to resume from the signal tapped off signal, those signal components which are dependent from the signal provided by generator 9.

1. A method for testing a hearing device with an input acoustical/electrical converter (5) with an acoustical input, an output electrical/acoustical converter (3) with an acoustical output, a computing unit (7) with an input operationally connected to the output of said acoustical/electrical converter and with an output operationally connected to the input of said electrical/acoustical converter comprising the steps of
a) placing said device in a position with freely accessible and freely communicating acoustical input and acoustical output;
b) generating at least one electric drive signal representing an acoustical signal;
c) driving said output converter with an electrical signal being a function of said drive signal;
d) tapping off an electric signal dependent from a signal at said output of said input converter;
e) determining from said signal tapped off characteristics of signal transfer in said device.

2. The method of claim 1, comprising the step of generating said electric drive signal representing an acoustical signal having a power higher than acoustical signals emanating from a surrounding of said device.

3. The method of claim 1, comprising monitoring surrounding noise of the hearing device and controlling said generating dependent on the result of said monitoring.

4. The method of claim 1, further comprising the step of determining from said signal tapped off signal components which are depending from said drive signal.

5. The method of claim 4, comprising performing said determining by correlating said signal tapped off and said drive signal.

6. The method of claim 1, further comprising generating said drive signal by means of a generator built into said hearing device.

7. The method of claim 1, further comprising the step of providing more than one of said electric drive signals and respectively activating selectively at least one of said more than one drive signals.

8. The method of claim 1, further comprising the step of performing determining said characteristics of signal transfer by comparing signals dependent from said signals taped off with predetermined rated signal values.

9. The method of claim 8, further comprising the step of storing said predetermined rated signal values in said hearing device.

10. The method of claim 1, further comprising the step of performing determining said characteristics within said hearing device.

11. The method of claim 1, further comprising disabling electrical operational connection of the output of said input converter to the input of said output converter at a predetermined location along an electric signal transfer path between said output and said input and through said hearing device, and driving said output converter with said electric signal by coupling said electric signal into said signal transfer path upstream said disabling and tapping off said electric signal dependent from a signal at said output of said input converter, downstream said disabling.

12. The method of claim 10, further comprising at least two locations upstream said disabling for coupling in said electric signal for driving said output converter.

13. The method of claim 12, further comprising the steps of selectively switching said electric signal for driving to said locations.

14. The method of one of claims 11 to 12, further comprising the step of providing more than one location downstream said disabling for tapping off said electric signal dependent from a signal at said output of said input converter.

15. The method of claim 14, further comprising the step of selectively switching said tapped off signal from said locations.

16. The method of one of claims 11 to 12, further comprising the step of first applying an acoustical signal from an external signal source to said input converter, tapping off a signal at the output of said input converter and analyzing by said signal tapped off the characteristics of said input converter.

17. The method of claim 1, further comprising the step of applying said acoustical signal from an electrical/acoustical output converter of a further hearing device.

18. The method of claim 1, further comprising the step of storing said characteristics determined.

19. The method of claim 18, further comprising the step of storing said characteristics determined within said hearing device.

20. A test system for a hearing device consisting of said hearing device having a data link to an evaluation unit.

21. The system of claim 20 wherein said data link is one of a wireless and of a wired link.

22. A method for manufacturing a tested hearing device comprising the steps of assembling a hearing device at least with at least one input acoustical/electrical converter, the output thereof being operationally connected to a computing unit, the output thereof being operationally connected to an input of an output acoustical/electrical converter,
generating by means of said output converter at least one acoustical test signal,
freely transmitting said acoustical test signal from the output of said output converter to the input of said input converter and analyzing at least one signal tapped off said hearing device between said output of said input converter and said input of said output converter as an indicative signal of malfunctioning or wellfunctioining of said device and differently treating a hearing device which is wellfunctioning.
